(19) United States
(12) Patent Application Publication
(10) Pub. No.: US 2026/0304168 A1
(43) Pub. Date: Oct. 1, 2026

(54) SYSTEMS AND METHODS FOR DETERMINING AN ACCURACY OF A NETWORK-SIDE BEAM MANAGEMENT MODEL

(71) Applicant: VIAVI Solutions Inc., Chandler, AZ (US)

(72) Inventors: Yun CHEN, Stevenage (GB); Onur DIZDAR, London (GB); Ankit GUPTA, Welwyn Garden City (GB); Stephen WANG, London (GB)

(21) Appl. No.: 19/092,120

(22) Filed: Mar. 27, 2025

(51) Int. Cl. H04W 24/08; H04L 41/5009

(52) U.S. Cl. CPC H04W 24/08; H04L 41/5009

(57) ABSTRACT

In some implementations, a user equipment (UE) may determine a set of layer 1 reference signal received power (L1-RSRP) values for a set B of beams. The UE may determine a set of probabilities for a set A of beams based on the set of L1-RSRP measurement values. The set of probabilities may include, for each beam, a respective probability that the beam is in a first group of beams having a higher L1-RSRP measurement value than other beams that are not included in the first group of beams. The UE may compare the first group of beams and a second group of beams, of the set A of beams, from the base station. The UE may determine an accuracy associated with the base station determining the second group of beams based on comparing the first group of beams and the second group of beams.

### BACKGROUND

In some wireless communication systems, beam management may be performed to support static beamforming. In some cases, a downlink beam management procedure may consist of three stages. The first stage may include establishing an initial beam pair. The initial beam pair may include a transmit beam and a receive beam. The second stage may include refining the transmit beam. The third stage may include refining the receive beam.

### SUMMARY

Some implementations described herein relate to a method performed by a user equipment (UE). The method may include determining a set of layer 1 reference signal received power (L1-RSRP) measurement values for a set B of beams, wherein the set of L1-RSRP measurement values includes a respective L1-RSRP measurement value for each beam of the set B of beams. The method may include determining a set of probabilities for a set A of beams based on the set of L1-RSRP measurement values, wherein the set of probabilities includes, for each beam of the set A of beams, a respective probability that each beam is in a first group of beams, of the set A of beams, having a higher L1-RSRP value than other beams, of the set A of beams, that are not included in the first group of beams. The method may include identifying the first group of beams based on the set of probabilities. The method may include transmitting information identifying the set of L1-RSRP measurement values to a base station. The method may include receiving information identifying a second group of beams, of the set A of beams, from the base station. The method may include comparing the first group of beams and the second group of beams. The method may include determining a prediction accuracy associated with the base station determining the second group of beams based on comparing the first group of beams and the second group of beams. The method may include transmitting information associated with the prediction accuracy to the base station.

Some implementations described herein relate to a method performed by a base station. The method may include performing beam sweeping within a set B of beams. The method may include receiving, from a UE, a set of L1-RSRP measurement values for the set B of beams and information identifying a first group of beams, wherein the set of L1-RSRP measurement values includes a respective L1-RSRP measurement value for each beam of the set B of beams. The method may include determining a set of probabilities for a set A of beams based on the set of L1-RSRP measurement values, wherein the set of probabilities includes, for each beam of the set A of beams, a respective probability that each beam is in a second group of beams, of the set A of beams, having a higher L1-RSRP measurement value than other beams, of the set A of beams, that are not included in the second group of beams. The method may include determining the second group of beams based on the set of probabilities. The method may include comparing the first group of beams and the second group of beams. The method may include determining a prediction accuracy associated with determining the second group of beams based on comparing the first group of beams and the second group of beams.

Some implementations described herein relate to a UE. The UE may include one or more memories and one or more processors coupled to the one or more memories. The one or more processors may be configured to determine a set of L1-RSRP measurement values for a set B of beams, wherein the set of L1-RSRP measurement values includes a respective L1-RSRP measurement value for each beam of the set B of beams. The one or more processors may be configured to determine a set of probabilities for a set A of beams based on the set of L1-RSRP measurement values, wherein the set of probabilities includes, for each beam of the set A of beams, a respective probability that each beam is in a first group of beams, of the set A of beams, having a higher L1-RSRP measurement value than other beams, of the set A of beams, that are not included in the first group of beams. The one or more processors may be configured to determine the first group of beams based on the set of probabilities. The one or more processors may be configured to transmit information identifying the set of L1-RSRP measurement values to a base station. The one or more processors may be configured to receive information identifying a second group of beams, of the set A of beams, from the base station. The one or more processors may be configured to compare the first group of beams and the second group of beams. The one or more processors may be configured to determine a prediction accuracy associated with the base station determining the second group of beams based on comparing the first group of beams and the second group of beams. The one or more processors may be configured to transmit information associated with the prediction accuracy to the base station.

Some implementations described herein relate to a base station. The base station may include one or more memories and one or more processors coupled to the one or more memories. The one or more processors may be configured to perform beam sweeping within a set B of beams. The one or more processors may be configured to receive, from a UE, a set of L1-RSRP measurement values for the set B of beams and information and information identifying a first group of beams, wherein the set of L1-RSRP measurement values includes a respective L1-RSRP measurement value for each beam of the set B of beams. The one or more processors may be configured to determine a set of probabilities for a set A of beams based on the set of L1-RSRP measurement values, wherein the set of probabilities includes, for each beam of the set A of beams, a respective probability that each beam is in a second group of beams, of the set A of beams, having a higher L1-RSRP measurement value than other beams, of the set A of beams, that are not included in the second group of beams. The one or more processors may be configured to compare the first group of beams and the second group of beams. The one or more processors may be configured to determine a prediction accuracy associated with determining the second group of beams based on comparing the first group of beams and the second group of beams.

Some implementations described herein relate to a non-transitory computer-readable medium that stores a set of instructions. The set of instructions, when executed by one or more processors of a UE, may cause the UE to determine a set of L1-RSRP measurement values for a set B of beams, wherein the set of L1-RSRP measurement values includes a respective L1-RSRP measurement value for each beam of the set B of beams. The set of instructions, when executed by one or more processors of the UE, may cause the UE to determine a set of probabilities for a set A of beams based on the set of L1-RSRP measurement values, wherein the set of probabilities includes, for each beam of the set A of beams, a respective probability that each beam is in a first group of beams, of the set A of beams, having a higher L1-RSRP value than other beams, of the set A of beams, that are not included in the first group of beams. The set of instructions, when executed by one or more processors of the UE, may cause the UE to determine the first group of beams based on the set of probabilities. The set of instructions, when executed by one or more processors of the UE, may cause the UE to transmit information identifying the first group of beams to a base station. The set of instructions, when executed by one or more processors of the UE, may cause the UE to receive information identifying a second group of beams, of the set A of beams, from the base station. The set of instructions, when executed by one or more processors of the UE, may cause the UE to compare the first group of beams and the second group of beams. The set of instructions, when executed by one or more processors of the UE, may cause the UE to determine a prediction accuracy associated with the base station determining the second group of beams based on comparing the first group of beams and the second group of beams. The set of instructions, when executed by one or more processors of the UE, may cause the UE to transmit information associated with the prediction accuracy to the base station.

Some implementations described herein relate to a non-transitory computer-readable medium that stores a set of instructions. The set of instructions, when executed by one or more processors of a base station, may cause the base station to perform beam sweeping within a set B of beams. The set of instructions, when executed by one or more processors of the base station, may cause the base station to receive, from a UE, a set of L1-RSRP measurement values for the set B of beams and information and information identifying a first group of beams, wherein the set of L1-RSRP measurement values includes a respective L1-RSRP measurement value for each beam of the set B of beams. The set of instructions, when executed by one or more processors of the base station, may cause the base station to determine a set of probabilities for a set A of beams based on the set of L1-RSRP measurement values, wherein the set of probabilities includes, for each beam of the set A of beams, a respective probability that each beam is in a second group of beams, of the set A of beams, having a higher L1-RSRP measurement value than other beams, of the set A of beams, that are not included in the second group of beams. The set of instructions, when executed by one or more processors of the base station, may cause the base station to determine the second group of beams based on the set of probabilities. The set of instructions, when executed by one or more processors of the base station, may cause the base station to compare the first group of beams and the second group of beams. The set of instructions, when executed by one or more processors of the base station, may cause the base station to determine a prediction accuracy associated with determining the second group of beams based on comparing the first group of beams and the second group of beams.

### BRIEF DESCRIPTION OF THE DRAWINGS

FIG. 1 is a diagram of example implementation associated with training a model to predict a top-N set of beams.

FIG. 2 is a diagram of an example implementation associated with determining an accuracy of a network-side beam management model.

FIG. 3 is a diagram of an example implementation associated with determining an accuracy of a network-side beam management model.

FIG. 4 is a diagram of an example environment in which systems and/or methods described herein may be implemented.

FIG. 5 is a diagram of example components of a device associated with determining an accuracy of a network-side beam management model.

FIG. 6 is a flowchart of an example process associated with determining an accuracy of a network-side beam management model.

FIG. 7 is a flowchart of an example process associated with determining an accuracy of a network-side beam management model.

### DETAILED DESCRIPTION

The following detailed description of example implementations refers to the accompanying drawings. The same reference numbers in different drawings may identify the same or similar elements.

In some wireless communication networks, beam management may be used to support static beamforming without the requirement of dynamic channel state information (CSI) estimation. In some cases, a downlink beam management procedure consists of three stages, including initial beam pair establishment, transmit beam refinement, and receive beam refinement. To simplify the beam management process, as well as reduce the signaling overhead, a network and/or a user equipment (UE) may use artificial intelligence (AI)/machine learning (ML) based beam management methods. In some cases, to implement an AI/ML-based beam management procedure, neural networks may be trained to conduct spatial and temporal domain prediction with one half or fewer layers to predict layer 1 reference signal received power (L1-RSRP) measurements of beams.

In some cases, two sets of beams may be determined for both spatial and temporal domain prediction. A first set of beams, Set A (referred to herein as a “set A of beams”), consists of the targeted beams that are to be predicted by an AI/ML algorithm. A second set of beams, Set B (referred to herein as a “set B of beams”), consists of beams that are used for beam sweeping to obtain the L1-RSRP measurements.

In some cases, an AI/ML algorithm or model may be used to predict the top-N beams (e.g., a set of beams having a higher L1-RSRP relative to the other beams) among the beams included in the set A of beams. In some cases, the L1-RSRPs determined for the set B of beams may be provided to the AI/ML algorithm or model as inputs and the AI/ML algorithm or model may generate an output indicating the top-N beams among the beams included in the set A of beams.

In some cases, a performance of the AI/ML algorithm or model may be monitored and one or more key performance indicators (KPIs) may be determined based on monitoring the performance of the AI/ML algorithm or model.

Some implementations described herein relate to utilizing a user equipment (UE)-side AI/ML algorithm or model to determine one or more KPIs associated with a network-side AI/ML algorithm or model. In some aspects, a UE may determine a set of L1-RSRP measurement values for a set B of beams and may transmit information indicating the set of L1-RSRP measurement values to a base station associated with the network-side AI/ML algorithm or model. The UE may determine a set of probabilities for a set A of beams based on the set of L1-RSRP measurement values. In some aspects, the set of probabilities includes, for each beam included in the set A of beams, a respective probability that the beam is in a top-N set of beams.

In some aspects, the UE may determine the top-N set of beams based on the set of probabilities and may receive, from the base station, information indicating a top-N set of beams determined by base station using the network-side model. In some aspects, the UE may determine an accuracy associated with the network-side model based on a comparison of the top-N set of beams determined by the UE and the top-N set of beams determined by the base station.

In some aspects, the UE may transmit information indicating the accuracy associated with the network-side model to the base station to enable the base station to re-train or refine the network-side AI/ML algorithm or model. As a result, an accuracy of the network-side AI/ML algorithm or model may be increased. Further, increasing an accuracy of the network-side model may result in a better prediction of a set B of beams, thereby resulting in an increase in a throughput and a robustness of a multi-antenna wireless network. In addition, systems and methods described herein may be easily integrated with an existing life cycle management framework of an AI/ML algorithm or model.

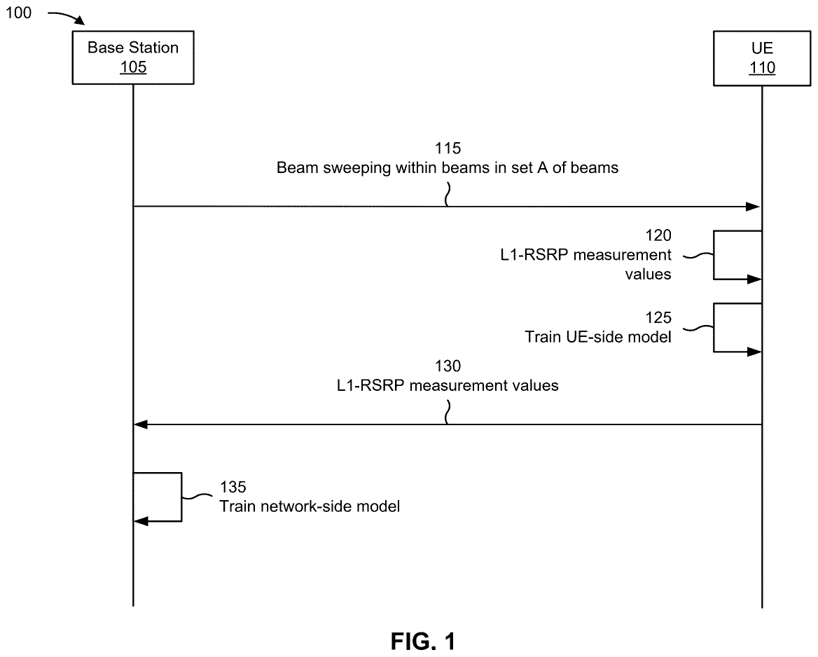

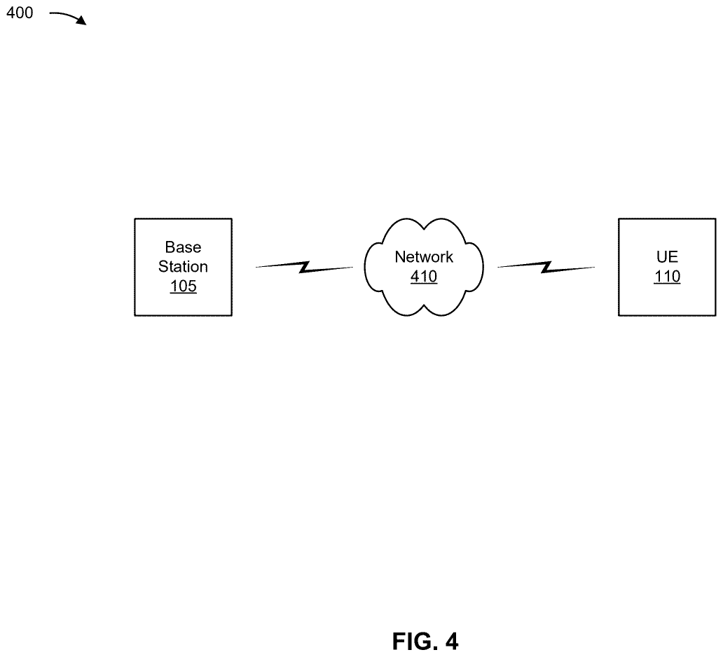

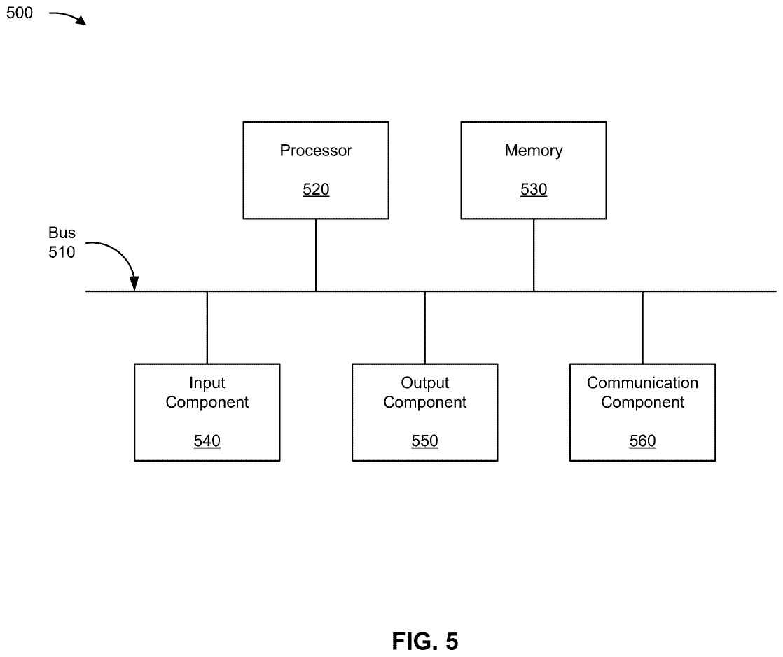

FIG. 1 is a diagram of example implementation 100 associated with training a model to predict a top-N set of beams. As shown in FIG. 1, example implementation 100 includes a base station (BS) 105 and a UE 110. These devices are described in more detail below in connection with FIG. 4 and FIG. 5. In some aspects, the base station 105 and the UE 110 may communicate via a wireless communication network (e.g., network 410, described below with respect to FIG. 4).

However, the devices shown in FIG. 1 are provided as examples, and the wireless communication network may support communication and beam management between other devices (e.g., between a UE 110 and a network node or a transmit receive point (TRP), between a mobile termination node and a control node, between an integrated access and backhaul (IAB) child node and an IAB parent node, or between a scheduled node and a scheduling node). In some aspects, the base station 105 and the UE 110 may be in a connected state (e.g., a radio resource control (RRC) connected state).

As shown by reference number 115, the base station 105 may conduct beam sweeping within beams included in a set A of beams. In some aspects, the base station 105 may conduct beam sweeping by transmitting signals over multiple transmit beams. For example, the base station 105 may transmit, to the UE 110, channel state information reference signals (CSI-RSs) or synchronization signal blocks (SSBs) over a set A of beams.

In some aspects, the signals may be configured to be (e.g., using RRC signaling), semi-persistent (e.g., using media access control (MAC) control element (MAC-CE) signaling), or aperiodic (e.g., using downlink control information (DCI)). In some aspects, to enable the UE 110 to perform receive beam sweeping, the base station 105 may use a transmit beam to transmit (e.g., with repetitions) each signal at multiple times within the same resource set so that the UE 110 can sweep through receive beams in multiple transmission instances.

For example, if the base station 105 has a set A of N transmit beams and the UE 110 has a set of M receive beams, the signal may be transmitted on each of the N transmit beams M times so that the UE 110 may receive M instances of the signal per transmit beam. In other words, for each transmit beam of the base station 105, the UE 110 may perform beam sweeping through the receive beams of the UE 110. In this way, base station 105 may enable the UE 110 to measure a signal on different transmit beams using different receive beams to support selection of base station 105 transmit beam(s)/UE 110 receive beam(s) beam pair(s).

As shown by reference number 120, the UE 110 may determine a set of L1-RSRP measurement values associated with the set A of beams. In some aspects, the UE 110 may determine multiple sets of L1-RSRPs. For example, the UE 110 may determine N×M sets of L1-RSRP measurement values based on the base station 105 transmitting the signal on each of the N transmit beams M times.

In some aspects, the UE 110 may utilize AI/ML algorithms and/or models (referred to collectively and individually as a “model”) to predict, based on the set of L1-RSRP measurement values calculated for a set B of beams, a respective L1-RSRP measurement value for each beam that is included in the set A of beams and is not included in the set B of beams.

In some aspects, the UE 110 may include a UE-side model and, as shown by reference number 125, the UE 110 may train the UE-side model to predict the L1-RSRP measurement values for the set A of beams based on one or more sets of L1-RSRP measurement values determined by the UE 110. Additionally, or alternatively, the UE 110 may train the UE-side model to predict a group of beams (e.g., a top-N set of beams, wherein N is an integer greater than or equal to one) associated with a highest L1-RSRP measurement value relative to the L1-RSRP measurement values determined or predicted for other beams included in the set A of beams, based on the one or more sets of L1-RSRP measurement values determined by the UE 110. In some aspects, the UE-side model may be trained using back propagation and a pre-defined loss function.

As shown by reference number 130, the UE 110 may transmit, and the base station 105 may receive, information indicating one or more sets of L1-RSRP measurement values determined by the UE 110. For example, the UE 110 may transmit information indicating each set of L1-RSRP measurement values of the one or more sets of L1-RSRP measurement values determined by the UE 110.

In some aspects, the base station 105 may utilize a network-side model to predict, based on sets of L1-RSRP measurement values calculated by one or more UEs (e.g., the UE 110 and/or one or more other UEs) for a set B of beams, a respective L1-RSRP measurement value for each beam that is included in the set A of beams and is not included in the set B of beams. In some aspects, as shown by reference number 135, the base station 105 may train the network-side model to predict the L1-RSRP measurement values for the set A of beams based on one or more sets of L1-RSRP measurement values determined by the UE 110 and/or one or more sets of L1-RSRP measurement values determined by one or more other UEs. Additionally, or alternatively, the base station 105 may train the network-side model to predict a group of beams (e.g., a top-N set of beams) associated with a highest L1-RSRP measurement value relative to the L1-RSRP measurement values determined or predicted for other beams included in the set A of beams, based on the one or more sets of L1-RSRP measurement values. In some aspects, the network-side model may be trained using back propagation and a pre-defined loss function.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

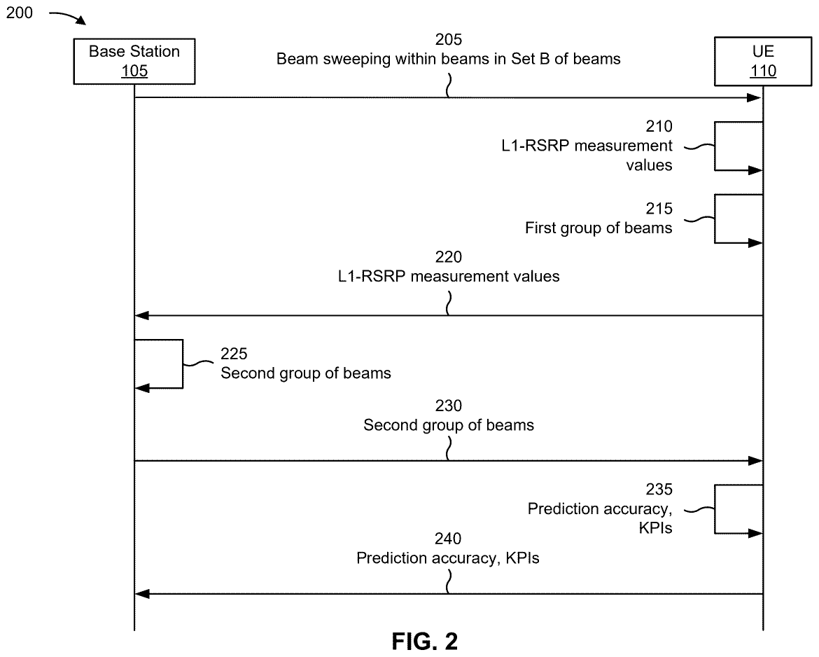

FIG. 2 is a diagram of an example implementation 200 associated with determining an accuracy of a network-side beam management model. As shown in FIG. 2, example implementation 200 includes a base station 105 and a UE 110. These devices are described in more detail below in connection with FIG. 4 and FIG. 5.

As shown by reference number 205, the base station 105 may conduct beam sweeping within a set B of beams. In some aspects, the base station 105 may determine the set B of beams based on conducting beam sweeping within a set A of beams. For example, the base station 105 may conduct beam sweeping within a set A of beams in a manner similar to that described above with respect to FIG. 1.

In some aspects, to enable the UE 110 to perform receive beam sweeping, the base station 105 may use a transmit beam to transmit (e.g., with repetitions) each signal at multiple times within the same resource set so that the UE 110 can sweep through receive beams in multiple transmission instances. In this way, base station 105 may enable the UE 110 to measure a signal on different transmit beams using different receive beams to support selection of base station 105 transmit beam(s)/UE 110 receive beam(s) beam pair(s).

In some aspects, the UE 110 may report the measurements to the base station 105 to enable the base station 105 to select one or more beam pairs for communication between the base station 105 and the UE 110. In some aspects, the base station 105 may determine the set B of beams based on the one or more selected beam pairs and may conduct beam sweeping within the determined set B of beams.

In some aspects, the set B of beams may be a subset of the set A of beams. In some aspects, the set B of beams may be different from the set A of beams. For example, one or more beams included in the set B of beams may not be included in the set A of beams. In some aspects, the base station 105 may transmit one or more signals (e.g., CSI-RSs or SSBs, among other examples) using each transmit beam of the set B of beams.

In some aspects, the one or more signals may be configured to be aperiodically transmitted by the base station 105. For example, the base station 105 may transmit, and the UE 110 may receive, DCI scheduling the transmission of the one or more signals.

In some aspects, the UE 110 may measure each signal using a single (e.g., same) receive beam (e.g., determined based on the measurements performed in connection with the base station 105 conducting beam sweeping via the set A of beams). For example, the UE 110 may calculate a set of L1-RSRPs based on the signals transmitted by the base station 105 via the set B of beams.

As shown by reference number 210, the UE 110 may determine a set of L1-RSRP measurement values for a set A of beams based on the set of L1-RSRP measurement values determined for the set B of beams. In some aspects, the UE 110 may include a UE-side model that has been trained to determine the L1-RSRP measurement values for the set A of beams and/or a top-N set of beams based on one or more sets of L1-RSRP measurement values determined by the UE 110. For example, the UE-side model may be trained to determine one or more sets of L1-RSRP measurement values and/or a top-N set of beams in a manner similar to that described above with respect to FIG. 1.

In some aspects, the UE 110 may provide the set of L1-RSRP measurement values determined for the set B of beams as inputs to the UE-side model. The UE-side model may analyze the L1-RSRP measurement values and may generate an output indicating a respective L1-RSRP measurement value for each beam included in the set A of beams.

Additionally, or alternatively, the output may indicate, for each beam included in the set A of beams, whether the beam is included in a top-N set of beams (where N is an integer greater than or equal to one) and/or a probability of the beam being included in the top-N set of beams. For example, the output may indicate, for each beam, a value and/or probability information.

In some aspects, the value may be a first value (e.g., 1) indicating that the beam is included in the top-N set of beams, or a second value (e.g., 2) indicating that the beam is not included in the top-N set of beams. In some aspects, the probability information may be information indicating a likelihood that a beam will be included in the top-N set of beams. For example, the probability information may indicate a percent chance (e.g., 10%, 20%, or the like) of the beam being included in the top-N set of beams.

As shown by reference number 215, the UE 110 may determine a first group of beams (e.g., a top-N set of beams) based on the output generated by the UE-side model. For example, the UE 110 may determine the first group of beams based on the L1-RSRP measurement values, the probability information, and/or the indication of whether each beam is included in the top-N set of beams included in the output generated by the UE-side model.

As shown by reference number 220, the UE 110 may transmit, and the base station 105 may receive, information indicating the set of L1-RSRP measurement values determined by the UE 110 for the set B of beams. In some aspects, the UE 110 may transmit additional information to the base station 105. For example, the UE 110 may also transmit information indicating the L1-RSRP measurement values determined by the UE-side model for the set A of beams and/or information identifying the first group of beams (e.g., an identifier associated with each beam included in the first group of beams).

As shown by reference number 225, the base station 105 may determine a second group of beams (e.g., a top-N set of beams) based on the set of L1-RSRP measurement values received from the UE 110. In some aspects, the base station 105 may include a network-side model that has been trained to predict, based on sets of L1-RSRP measurement values for a set B of beams calculated by multiple different UEs (e.g., the UE 110 and one or more other UEs), a respective L1-RSRP measurement value for each beam that is included in the set A of beams and is not included in the set B of beams and/or a group of beams (e.g., a top-N set of beams) associated with a highest L1-RSRP measurement value relative to the L1-RSRP measurement values determined or predicted for other beams included in the set A of beams. In some aspects, the base station 105 may train the network-side model to predict the L1-RSRP measurement values for the set A of beams and/or the group of beams, in a manner similar to that described above with respect to FIG. 1.

In some aspects, the base station 105 may provide the set of L1-RSRP measurement values received from the UE 110 as inputs to the network-side model. The network-side model may analyze the L1-RSRP measurement values and may generate an output indicating a respective L1-RSRP measurement value for each beam included in the set A of beams.

Additionally, or alternatively, the output may indicate, for each beam included in the set A of beams, whether the beam is included in a top-N set of beams and/or a likelihood of the beam being included in the top-N set of beams. For example, the output may indicate, for each beam, a value and probability information.

In some aspects, the value may be a first value (e.g., 1) indicating that the beam is included in the top-N set of beams or a second value (e.g., 2) indicating that the beam is not included in the top-N set of beams. In some aspects, the probability information may be information indicating a likelihood that a beam will be included in the top-N set of beams. For example, the probability information may indicate a percent chance (e.g., 10%, 20%, or the like) of the beam being included in the top-N set of beams.

In some aspects, the base station 105 may determine the second group of beams (e.g., a top-N set of beams) based on the output generated by the network-side model. For example, the base station 105 may determine the second group of beams based on the L1-RSRP measurement values, the probability information, and/or the indication of whether each beam is included in the top-N set of beams included in the output generated by the network-side model.

As shown by reference number 230, the base station 105 may transmit, and the UE 110 may receive, information indicating the second group of beams. In some aspects, the base station 105 may transmit the information indicating the second group of beams via a beam included in the second group of beams. In some aspects, the base station 105 may transmit the information indicating the second group of beams via a beam associated with a highest L1-RSRP measurement value relative to L1-RSRP measurement values associated with other beams included in the second group of beams.

In some aspects, the second group of beams may be a top-1 set of beams (e.g., the second group of beams includes a single beam associated with a highest L1-RSRP measurement value relative to other beams included in the second group of beams). In these aspects, the base station 105 may transmit the information indicating the second group of beams via the beam included in the second group of beams based on the beam being the only beam included in the second group of beams.

In some aspects, the information indicating the second group of beams may be transmitted with downlink data. For example, the information indicating the second group of beams may be included with downlink data in a physical downlink shared channel (PDSCH) transmission to the UE 110.

In some aspects, the information indicating the second group of beams may include probability information determined by the network-side model. In some aspects, the probability information included with the information indicating the second group of beams may include the probability information determined for beams included in the second group of beams, the probability information determined for the set B of beams, the probability information determined for beams included in the set A of beams that are not included in the set B of beams, and/or the probability information determined for the set A of beams.

In some aspects, the information indicating the second group of beams may include a set of L1-RSRP measurement values. For example, the information indicating the second group of beams may include a set of L1-RSRP measurement values associated with the second group of beams, the set B of beams, a set of beams included in the set A of beams that are not included in the set B of beams, and/or the set A of beams.

As shown by reference number 235, the UE 110 may determine a prediction accuracy and/or one or more KPIs associated with the network-side model based on the information indicating the second group of beams. In some aspects, the UE 110 may utilize the UE-side model to determine the prediction accuracy and/or the one or more KPIs. For example, the UE 110 may provide information indicating the first group of beams, the second group of beams, the set of L1-RSRP measurement values determined by the UE 110 for the set B of beams, the set of L1-RSRP measurement values determined by the UE 110 for the set A of beams, the set of L1-RSRP measurement values determined by the base station 105 for the set A of beams, and/or the probability information as inputs to the UE-side model. The UE-side model may analyze the input information and may generate an output indicating the prediction accuracy and/or the one or more KPIs associated with the base station 105 and/or the network-side model.

In some aspects, the UE 110 may determine the prediction accuracy associated with the network-side model (rather than the base station 105 determining a prediction accuracy associated with the UE-side model) based on the UE-side model being trained using L1-RSRP measurement values determined by the UE 110. Because the network-side model is trained using L1-RSRP measurement values determined by multiple different UEs (that may or may not include the UE 110) under different channel conditions, an accuracy of the UE-side model with respect to determining a top-N set of beams for the UE 110 may be greater than an accuracy of the network-side model.

Additionally, the L1-RSRP measurement values used to train the UE-side model may have little (e.g., no) L1-RSRP quantization loss caused by a transmission of the L1-RSRP measurement values. In contrast, the network-side model may be trained using quantized L1-RSRP measurement values based on all of the L1-RSRP measurement values being transmitted to the base station 105 from the UE 110 and/or from one or more other UEs.

In some aspects, the UE 110 may determine the prediction accuracy associated with the network-side model based on comparing the first group of beams and the second group of beams. In some aspects, the UE 110 may determine the prediction accuracy based on a quantity of beams included in the second group of beams that are also included in the first group of beams. For example, the UE 110 may determine the prediction accuracy based on dividing the quantity of beams included in the second group of beams that are also included in the first group of beams by the total quantity of beams included in the first group of beams.

In some aspects, the UE 110 may determine the prediction accuracy based on whether the second group of beams matches (e.g., is exactly the same as) the first group of beams. For example, the UE 110 may determine that the prediction accuracy comprises a first accuracy (e.g., 1, 100%, accurate, or the like) when the second group of beams matches the first group of beams and a second accuracy (e.g., 0, inaccurate, or the like) when the second group of beams does not match the first group of beams.

In some aspects, the UE 110 may determine one or more KPIs associated with the base station 105 and/or the network-side model based on the second group of beams and/or other information included in the information identifying the second group of beams. In some aspects, the one or more KPIs may include a beam prediction accuracy KPI.

In some aspects, the beam prediction accuracy KPI may indicate an accuracy associated with the network-side model predicting a best beam. For example, the UE 110 may determine whether a beam included in the second group of beams that is associated with a highest L1-RSRP

measurement value relative to the other beams included in the second group of beams is the same as a beam included in the first group of beams that is associated with a highest L1-RSRP measurement value relative to the other beams included in the first group of beams.

In some aspects, the one or more KPIs may include a link quality KPI. In some aspects, the link quality KPI may be associated with a throughput, an L1-RSRP measurement value, an L1-signal-to-interference-plus-noise ratio (SINR), and/or a hypothetical block error rate (BLER) associated with a beam via which the information indicating the second group of beams was transmitted and/or received.

In some aspects, the one or more KPIs may include a performance metric based on input/output data distribution associated with the network-side model. For example, the UE 110 may determine a percentage of times that each beam is included in the set B of beams, the top-N set of beams, the first group of beams, and/or the second group of beams, among other examples.

As shown by reference number 240, the UE 110 may transmit, and the base station 105 may receive, information indicating the predication accuracy and/or the one or more KPIs. In some aspects, the base station 105 may perform one or more actions based on the prediction accuracy and/or the one or more KPIs. For example, the base station 105 may retrain the network-side model, modify the set A of beams, and/or modify one or more weights or coefficients of the network-side model, among other examples.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

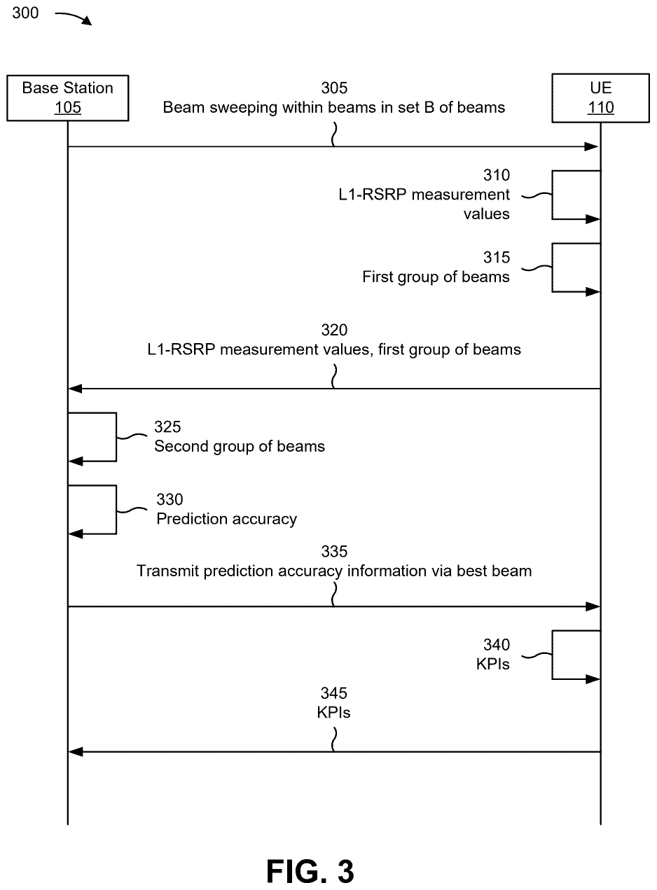

FIG. 3 is a diagram of an example implementation 300 associated with determining an accuracy of a network-side beam management model. As shown in FIG. 3, example implementation 300 includes a base station 105 and a UE 110. These devices are described in more detail below in connection with FIG. 4 and FIG. 5.

As shown by reference number 305, the base station 105 may conduct beam sweeping within beams included in the set B of beams. In some aspects, the base station 105 may determine the set B of beams based on conducting beam sweeping within a set A of beams. For example, the base station 105 may conduct beam sweeping within a set A of beams in a manner similar to that described above with respect to FIG. 1.

In some aspects, to enable the UE 110 to perform receive beam sweeping, the base station 105 may use a transmit beam to transmit (e.g., with repetitions) each signal at multiple times within the same resource set so that the UE 110 can sweep through receive beams in multiple transmission instances. In this way, base station 105 may enable the UE 110 to measure a signal on different transmit beams using different receive beams to support selection of base station 105 transmit beam(s)/UE 110 receive beam(s) beam pair(s).

In some aspects, the UE 110 may report the measurements to the base station 105 to enable the base station 105 to select one or more beam pairs for communication between the base station 105 and the UE 110. In some aspects, the base station 105 may determine the set B of beams based on the one or more selected beam pairs and may conduct beam sweeping within the determined set B of beams.

In some aspects, the set B of beams may be a subset of the set A of beams. In some aspects, the set B of beams may be different from the set A of beams. In some aspects, the base station 105 may transmit one or more signals (e.g., CSI-RSs or SSBs, among other examples) using each transmit beam of the set B of beams.

In some aspects, the one or more signals may be configured to be aperiodically transmitted by the base station 105. For example, the base station 105 may transmit, and the UE 110 may receive, DCI scheduling the transmission of the one or more signals.

In some aspects, the UE 110 may measure each signal using a single (e.g., same) receive beam (e.g., determined based on the measurements performed in connection with the base station 105 conducting beam sweeping via the set A of beams). For example, the UE 110 may calculate a set of L1-RSRPs based on the signals transmitted by the base station 105 via the set B of beams.

As shown by reference number 310, the UE 110 may determine a set of L1-RSRP measurement values for a set A of beams based on the set of L1-RSRP measurement values determined for the set B of beams. In some aspects, the UE 110 may include a UE-side model that has been trained to determine the L1-RSRP measurement values for the set A of beams and/or a top-N set of beams based on one or more sets of L1-RSRP measurement values determined by the UE 110. For example, UE-side model may be trained to determine one or more sets of L1-RSRP measurement values and/or a top-N set of beams in a manner similar to that described above with respect to FIG. 1.

In some aspects, the UE 110 may provide the set of L1-RSRP measurement values determined for the set B of beams as inputs to the UE-side model. The UE-side model may analyze the L1-RSRP measurement values and may generate an output indicating a respective L1-RSRP measurement value for each beam included in the set A of beams.

Additionally, or alternatively, the output may indicate, for each beam included in the set A of beams, whether the beam is included in a top-N set of beams (where N is an integer greater than or equal to one) and/or a probability of the beam being included in the top-N set of beams. For example, the output may indicate, for each beam, a value and/or probability information.

In some aspects, the value may be a first value (e.g., 1) indicating that the beam is included in the top-N set of beams or a second value (e.g., 2) indicating that the beam is not included in the top-N set of beams. In some aspects, the probability information may be information indicating a likelihood that a beam will be included in the top-N set of beams. For example, the probability information may indicate a percent chance (e.g., 10%, 20%, or the like) of the beam being included in the top-N set of beams.

As shown by reference number 315, the UE 110 may determine a first group of beams (e.g., a top-N set of beams) based on the output generated by the UE-side model. For example, the UE 110 may determine the first group of beams based on the L1-RSRP measurement values, the probability information, and/or the indication of whether each beam is included in the top-N set of beams included in the output generated by the UE-side model.

As shown by reference number 320, the UE 110 may transmit, and the base station 105 may receive, information indicating the L1-RSRP measurement values determined by the UE 110 for the set B of beams, information indicating the L1-RSRP measurement values determined by the UE-side model for the set A of beams, and/or information indicating the first group of beams. In some aspects, the UE 110 may transmit additional information to the base station 105. For example, the UE 110 may transmit information indicating the prediction information determined for each beam included in the set A of beams.

As shown by reference number 325, the base station 105 may determine a second group of beams (e.g., a top-N set of beams) based on the L1-RSRP measurement values received from the UE 110. In some aspects, the base station 105 may include a network-side model that has been trained to predict, based on sets of L1-RSRP measurement values for a set B of beams calculated by multiple different UEs (e.g., the UE 110 and one or more other UEs), a respective L1-RSRP measurement value for each beam that is included in the set A of beams and is not included in the set B of beams and/or a group of beams (e.g., a top-N set of beams) associated with a highest L1-RSRP measurement value relative to the L1-RSRP measurement values determined or predicted for other beams included in the set A of beams. In some aspects, the base station 105 may train the network-side model to predict the L1-RSRP measurement values for the set A of beams and/or the group of beams, in a manner similar to that described above with respect to FIG. 1.

In some aspects, the base station 105 may provide the set of L1-RSRP measurement values received from the UE 110 as inputs to the network-side model. The network-side model may analyze the L1-RSRP measurement values and may generate an output indicating a respective L1-RSRP measurement value for each beam included in the set A of beams.

Additionally, or alternatively, the output may indicate, for each beam included in the set A of beams, whether the beam is included in a top-N set of beams and/or a likelihood of the beam being included in the top-N set of beams. For example, the output may indicate, for each beam, a value and probability information.

In some aspects, the value may be a first value (e.g., 1) indicating that the beam is included in the top-N set of beams or a second value (e.g., 2) indicating that the beam is not included in the top-N set of beams. In some aspects, the probability information may be information indicating a likelihood that a beam will be included in the top-N set of beams. For example, the probability information may indicate a percent chance (e.g., 10%, 20%, or the like) of the beam being included in the top-N set of beams.

In some aspects, the base station 105 may determine the second group of beams (e.g., a top-N set of beams) based on the output generated by the network-side model. For example, the base station 105 may determine the second group of beams based on the L1-RSRP measurement values, the probability information, and/or the indication of whether each beam is included in the top-N set of beams included in the output generated by the network-side model.

As shown by reference number 330, the base station 105 may determine a prediction accuracy associated with the network-side model. In some aspects, the base station 105 may utilize the network-side model to determine the prediction accuracy. For example, the base station 105 may provide information indicating the first group of beams, the second group of beams, the set of L1-RSRP measurement values determined by the UE 110 for the set B of beams, the set of L1-RSRP measurement values determined by the UE 110 for the set A of beams, the set of L1-RSRP measurement values determined by the base station 105 for the set A of beams, and/or the probability information as inputs to the network-side model. The network-side model may analyze the input information and may generate an output indicating the prediction accuracy associated with the network-side model.

In some aspects, the base station 105 may determine the prediction accuracy associated with the network-side model based on comparing the first group of beams and the second group of beams. In some aspects, the base station 105 may determine the prediction accuracy based on a quantity of beams included in the second group of beams that are also included in the first group of beams. For example, the base station 105 may determine the prediction accuracy based on dividing the quantity of beams included in the second group of beams that are also included in the first group of beams by the total quantity of beams included in the first group of beams.

In some aspects, the base station 105 may determine the prediction accuracy based on whether the second group of beams matches the first group of beams. For example, the base station 105 may determine that the prediction accuracy comprises a first accuracy (e.g., 1, 100%, accurate, or the like) when the second group of beams matches the first group of beams and a second accuracy (e.g., 0, inaccurate, or the like) when the second group of beams does not match the first group of beams.

As shown by reference number 335, the base station 105 may transmit, and the UE 110 may receive, prediction accuracy information via the best beam. In some aspects, the prediction accuracy information may include information indicating the prediction accuracy determined by the base station 105.

In some aspects, the base station 105 may transmit the prediction accuracy information via a best beam included in the second group of beams. In some aspects, the best beam may correspond to a beam, included in the second group of beams, that is associated with a highest L1-RSRP measurement value relative to L1-RSRP measurement values associated with other beams included in the second group of beams.

In some aspects, the prediction accuracy information may be transmitted with downlink data. For example, the prediction accuracy information may be included with downlink data in PDSCH transmission to the UE 110.

In some aspects, the prediction accuracy information may include probability information determined by the network-side model. In some aspects, the probability information included with the prediction accuracy information may include the probability information determined for beams included in the second group of beams, the probability information determined for the set B of beams, the probability information determined for beams included in the set A of beams that are not included in the set B of beams, and/or the probability information determined for the set A of beams.

In some aspects, the information indicating the second group of beams may include a set of L1-RSRP measurement values. For example, the information indicating the second group of beams may include a set of L1-RSRP measurement values associated with the second group of beams, the set B of beams, a set of beams included in the set A of beams that are not included in the set B of beams, and/or the set A of beams.

As shown by reference number 340, the UE 110 may determine one or more KPIs associated with the base station 105 and/or the network-side model based on the prediction accuracy information and/or a reception of the prediction accuracy information via the best beam. In some aspects, the UE 110 may utilize the UE-side model to determine the one or more KPIs. For example, the UE 110 may provide information indicating the first group of beams, the second group of beams, the set of L1-RSRP measurement values determined by the UE 110 for the set B of beams, the set of L1-RSRP measurement values determined by the UE 110 for the set A of beams, the set of L1-RSRP measurement values determined by the base station 105 for the set A of beams, and/or the probability information as inputs to the UE-side model. The UE-side model may analyze the input information and may generate an output indicating the one or more KPIs associated with the base station 105 and/or the network-side model.

In some aspects, the one or more KPIs may include a beam prediction accuracy KPI, a link quality KPI, and/or a performance metric based on input/output data distribution associated with the network-side model, among other examples. For example, the UE 110 may determine a beam prediction accuracy KPI, a link quality KPI, and/or a performance metric based on input/output data distribution associated with the network-side model in a manner similar to that described above with respect to FIG. 2.

As shown by reference number 345, the UE 110 may transmit, and the base station 105 may receive, information indicating the one or more KPIs. In some aspects, the base station 105 may perform one or more actions based on the prediction accuracy and/or the one or more KPIs. For example, the base station 105 may retrain the network-side model, modify the set A of beams, and/or modify one or more weights or coefficients of the network-side model, among other examples.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

FIG. 4 is a diagram of an example environment 400 in which systems and/or methods described herein may be implemented. As shown in FIG. 4, environment 400 may include a base station 105, a UE 110, and a network 410. Devices of environment 400 may interconnect via wired connections, wireless connections, or a combination of wired and wireless connections.

Base station 105 includes one or more devices capable of communicating with a UE using a cellular radio access technology (RAT). For example, base station 105 may include a base transceiver station, a radio base station, a node B, an evolved node B (eNB), a gNB, a base station subsystem, a cellular site, a cellular tower (e.g., a cell phone tower or a mobile phone tower), an access point, a transmit receive point (TRP), a radio access node, a macrocell base station, a microcell base station, a picocell base station, a femtocell base station, or a similar type of device. Base station 105 may transfer traffic between a UE (e.g., using a cellular RAT), other base stations 105 (e.g., using a wireless interface or a backhaul interface, such as a wired backhaul interface), and/or network 410. Base station 105 may provide one or more cells that cover geographic areas. Some base stations 105 may be mobile base stations. Some base stations 105 may be capable of communicating using multiple RATs.

In some implementations, base station 105 may perform scheduling and/or resource management for UEs covered by base station 105 (e.g., UEs covered by a cell provided by base station 105). In some implementations, base stations 105 may be controlled or coordinated by a network controller, which may perform load balancing and/or network-level configuration. The network controller may communicate with base stations 105 via a wireless or wireline backhaul. In some implementations, base station 105 may include a network controller, a self-organizing network (SON) module or component, or a similar module or component. In other words, a base station 105 may perform network control, scheduling, and/or network management functions (e.g., for other base stations 105 and/or for uplink, downlink, and/or sidelink communications of UEs covered by the base station 105). In some implementations, base station 105 may include a central unit and multiple distributed units. The central unit may coordinate access control and communication with regard to the multiple distributed units. The multiple distributed units may provide UEs and/or other base stations 105 with access to network 410.

In some implementations, base station 105 may be capable of multiple input multiple output (MIMO) communication (e.g., beamformed communication). In some implementations, base station 105 may include a calibration component for phase calibration of signals produced or received by base station 105, as described elsewhere herein. In a testing scenario, one or more antenna elements (e.g., an antenna array) of base station 105 may be disconnected, and base station 105 may be connected to a test panel, as described elsewhere herein.

UE 110 may include one or more devices capable of communicating with base station 105 and/or a network (e.g., network 410). For example, UE 110 may include a wireless communication device, a radiotelephone, a personal communications system (PCS) terminal (e.g., that may combine a cellular radiotelephone with data processing and data communications capabilities), a smart phone, a laptop computer, a tablet computer, a personal gaming system, user equipment, and/or a similar device. UE 110 may be capable of communicating using uplink (e.g., UE to base station) communications, downlink (e.g., base station to UE) communications, and/or sidelink (e.g., UE-to-UE) communications. In some implementations, UE 110 may include a machine-type communication (MTC) UE, such as an evolved or enhanced MTC (eMTC) UE. In some implementations, UE 110 may include an Internet of Things (IoT) UE, such as a narrowband IoT (NB-IoT) UE.

Network 410 includes one or more wired and/or wireless networks. For example, network 410 may include a cellular network (e.g., a long-term evolution (LTE) network, a code division multiple access (CDMA) network, a 3G network, a 4G network, a 5G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with determining an accuracy of a network-side beam management model. The device 500 corresponds to one or more of the base station 105 and/or the UE 110. In some implementations, the base station 105 and/or the UE 110 include one or more devices 500 and/or one or more components of the device 500. In the example shown in FIG. 5, the device 500 includes a bus 510, a processor 520, a memory 530, an input component 540, an output component 550, and/or a communication component 560.

The bus 510 includes one or more components that enable wired and/or wireless communication among the components of the device 500. The bus 510 couples together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 includes a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 includes one or more processors capable of being programmed to perform one or more operations or processes described elsewhere herein.

The memory 530 includes volatile and/or nonvolatile memory, such as random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). In some implementations, the memory 530 is a non-transitory computer-readable medium. The memory 530 stores information, one or more instructions, and/or software (e.g., one or more software applications) related to the operation of the device 500. In some implementations, the memory 530 includes one or more memories that are coupled (e.g., communicatively coupled) to one or more processors (e.g., processor 520), such as via the bus 510. Communicative coupling between a processor 520 and a memory 530 enables the processor 520 to read and/or process information stored in the memory 530 and/or to store information in the memory 530.

The input component 540 enables the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 enables the device 500 to provide output, such as via a display, a speaker, and/or a light-emitting diode. The communication component 560 enables the device 500 to communicate with other devices via a wired connection and/or a wireless connection. For example, the communication component 560 may include a receiver, a transmitter, a transceiver, a modem, a network interface card, and/or an antenna.

In some implementations, the device 500 performs one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

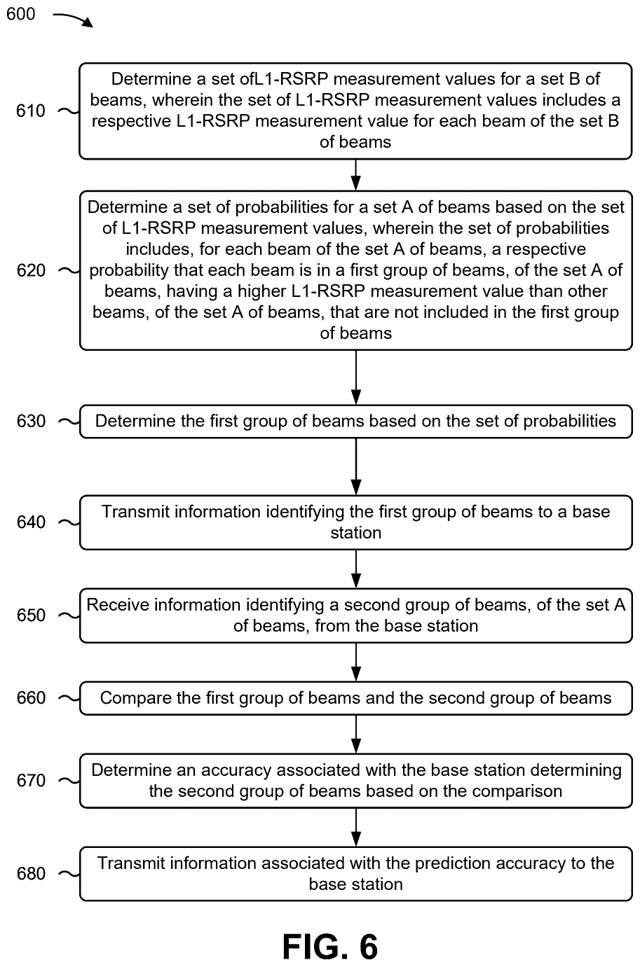

FIG. 6 is a flowchart of an example process 600 associated with determining an accuracy of a network-side beam management model. One or more process blocks of FIG. 6 are performed by a UE (e.g., UE 110) and/or by another device or a group of devices separate from or including the UE, such as a base station (e.g., base station 105). Additionally, or alternatively, one or more process blocks of FIG. 6 may be performed by one or more components of device 500, such as processor 520, memory 530, input component 540, output component 550, and/or communication component 560.

As shown in FIG. 6, process 600 includes determining a set of L1-RSRP measurement values for a set B of beams, wherein the set of L1-RSRP measurement values includes a respective L1-RSRP measurement value for each beam of the set B of beams (block 610). For example, the UE may determine a set of L1-RSRP measurement values for a set B of beams, wherein the set of L1-RSRP measurement values includes a respective L1-RSRP measurement value for each beam of the set B of beams, as described above.

As further shown in FIG. 6, process 600 includes determining a set of probabilities for a set A of beams based on the set of L1-RSRP measurement values, wherein the set of probabilities includes, for each beam of the set A of beams, a respective probability that each beam is in a first group of beams, of the set A of beams, having a higher L1-RSRP value than other beams, of the set A of beams, that are not included in the first group of beams (block 620). For example, the UE may determine a set of probabilities for a set A of beams based on the set of L1-RSRP measurement values, wherein the set of probabilities includes, for each beam of the set A of beams, a respective probability that each beam is in a first group of beams, of the set A of beams, having a higher L1-RSRP value than other beams, of the set A of beams, that are not included in the first group of beams, as described above.

As further shown in FIG. 6, process 600 includes identifying the first group of beams based on the set of probabilities (block 630). For example, the UE may identify the first group of beams based on the set of probabilities, as described above.

As further shown in FIG. 6, process 600 includes transmitting information identifying the set of L1-RSRP measurement values to a base station (block 640). For example, the UE may transmit information identifying the set of L1-RSRP measurement values to a base station, as described above.

As further shown in FIG. 6, process 600 includes receiving information identifying a second group of beams, of the set A of beams, from the base station (block 650). For example, the UE may receive information identifying a second group of beams, of the set A of beams, from the base station, as described above.

As further shown in FIG. 6, process 600 includes comparing the first group of beams and the second group of beams (block 660). For example, the UE may compare the first group of beams and the second group of beams, as described above.

As further shown in FIG. 6, process 600 includes determining a prediction accuracy associated with the base station determining the second group of beams based on comparing the first group of beams and the second group of beams (block 670). For example, the UE may determine a prediction accuracy associated with the base station determining the second group of beams based on comparing the first group of beams and the second group of beams, as described above.

As further shown in FIG. 6, process 600 includes transmitting information associated with the prediction accuracy to the base station (block 680). For example, the UE may transmit information associated with the prediction accuracy to the base station, as described above.

Process 600 may include additional aspects, such as any single aspect or any combination of aspects described below and/or in connection with one or more other processes described elsewhere herein.

In a first aspect, process 600 includes calculating a set of key performance indicators (KPIs) associated with the base station determining the second group of beams, wherein the set of KPIs is determined based on one or more of the set of L1-RSRP measurement values, the first group of beams, or the second group of beams, and transmitting information indicating the set of KPIs to the base station.

In a second aspect, alone or in combination with the first aspect, a quantity of beams included in one or more of the first group of beams or the second group of beams is one beam.

In a third aspect, alone or in combination with one or more of the first and second aspects, determining the prediction accuracy comprises determining that the prediction accuracy comprises a first value based on the first group of beams matching the second group of beams, or determining that the prediction accuracy comprises a second value, that is different from the first value, based on the first group of beams being different from the second group of beams.

In a fourth aspect, alone or in combination with one or more of the first through third aspects, receiving the information indicating the second group of beams comprises receiving a PDSCH communication that includes the information indicating the second group of beams.

In a fifth aspect, alone or in combination with one or more of the first through fourth aspects, the PDSCH communication further includes downlink data associated with the UE.

In a sixth aspect, alone or in combination with one or more of the first through fifth aspects, the information indicating the second group of beams is received via a beam included in the second group of beams.

In a seventh aspect, alone or in combination with one or more of the first through sixth aspects, the information indicating the set of L1-RSRP measurement values is transmitted via a beam included in the first group of beams.

In an eighth aspect, alone or in combination with one or more of the first through seventh aspects, transmitting the information indicating the set of L1-RSRP measurement values comprises transmitting the information indicating the set of L1-RSRP measurement values, the first group of beams, and the set of probabilities.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

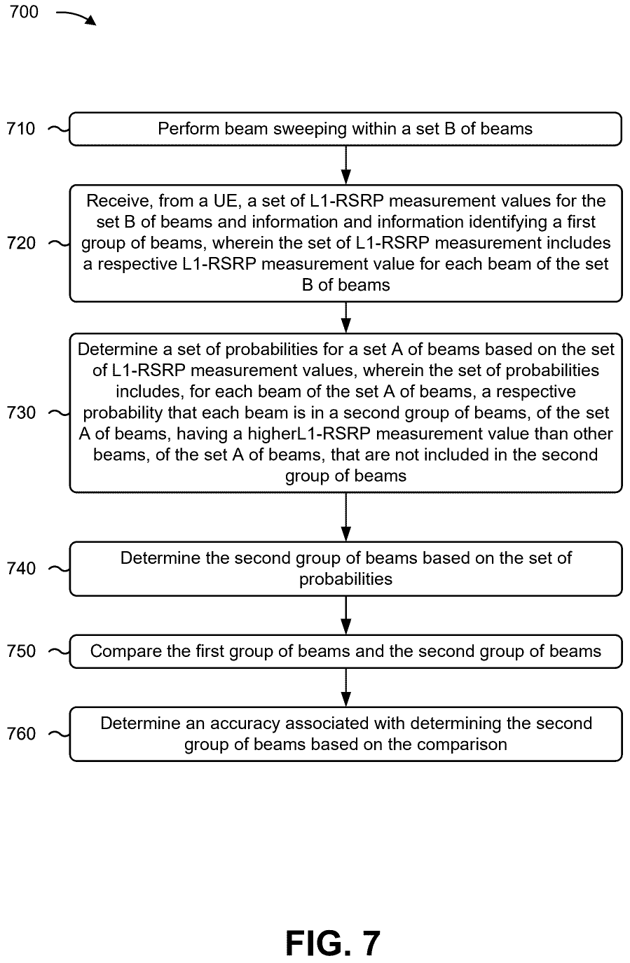

FIG. 7 is a flowchart of an example process 700 associated with determining an accuracy of a network-side beam management model. One or more process blocks of FIG. 7 are performed by a base station (e.g., base station 105) and/or by another device or a group of devices separate from or including the base station, such as a UE (e.g., UE 110). Additionally, or alternatively, one or more process blocks of FIG. 7 may be performed by one or more components of device 500, such as processor 520, memory 530, input component 540, output component 550, and/or communication component 560.

As shown in FIG. 7, process 700 includes performing beam sweeping within a set B of beams (block 710). For example, the base station may perform beam sweeping within a set B of beams, as described above.

As further shown in FIG. 7, process 700 includes receiving, from a UE, a set of L1-RSRP measurement values for the set B of beams and information identifying a first group of beams, wherein the set of L1-RSRP measurement values includes a respective L1-RSRP measurement value for each beam of the set B of beams (block 720). For example, the base station may receive, from a user equipment (UE), a set of L1-RSRP measurement values for the set B of beams and information identifying a first group of beams, wherein the set of L1-RSRP measurement values includes a respective L1-RSRP measurement value for each beam of the set B of beams, as described above.

As further shown in FIG. 7, process 700 includes determining a set of probabilities for a set A of beams based on the set of L1-RSRP measurement values, wherein the set of probabilities includes, for each beam of the set A of beams, a respective probability that each beam is in a second group of beams, of the set A of beams, having a higher L1-RSRP measurement value than other beams, of the set A of beams, that are not included in the second group of beams (block 730). For example, the base station may determine a set of probabilities for a set A of beams based on the set of L1-RSRP measurement values, wherein the set of probabilities includes, for each beam of the set A of beams, a respective probability that each beam is in a second group of beams, of the set A of beams, having a higher L1-RSRP measurement value than other beams, of the set A of beams, that are not included in the second group of beams, as described above.

As further shown in FIG. 7, process 700 includes determining the second group of beams based on the set of probabilities (block 740). For example, the base station may determine the second group of beams based on the set of probabilities, as described above.

As further shown in FIG. 7, process 700 includes comparing the first group of beams and the second group of beams (block 750). For example, the base station may compare the first group of beams and the second group of beams, as described above.

As further shown in FIG. 7, process 700 includes determining a prediction accuracy associated with determining the second group of beams based on comparing the first group of beams and the second group of beams (block 760). For example, the base station may determine a prediction accuracy associated with determining the second group of beams based on comparing the first group of beams and the second group of beams, as described above.

Process 700 may include additional aspects, such as any single aspect or any combination of aspects described below and/or in connection with one or more other processes described elsewhere herein.

In a first aspect, a quantity of beams included in one or more of the first group of beams or the second group of beams is one beam.

In a second aspect, alone or in combination with the first aspect, determining the prediction accuracy comprises determining that the prediction accuracy comprises a first value based on the first group of beams matching the second group of beams, or determining that the prediction accuracy comprises a second value, that is different from the first value, based on the first group of beams being different from the second group of beams.

In a third aspect, alone or in combination with one or more of the first and second aspects, information indicating the set of L1-RSRP measurement values and the first group of beams is received via a beam included in the first group of beams.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by a user equipment (UE), comprising:
determining a set of layer 1 reference signal received power (L1-RSRP) measurement values for a set B of beams, wherein the set of L1-RSRP measurement values includes a respective L1-RSRP measurement value for each beam of the set B of beams;
determining a set of probabilities for a set A of beams based on the set of L1-RSRP measurement values, wherein the set of probabilities includes, for each beam of the set A of beams, a respective probability that each beam is in a first group of beams, of the set A of beams, having a higher L1-RSRP value than other beams, of the set A of beams, that are not included in the first group of beams;
identifying the first group of beams based on the set of probabilities;
transmitting information identifying the set of L1-RSRP measurement values to a base station;
receiving information identifying a second group of beams, of the set A of beams, from the base station;
comparing the first group of beams and the second group of beams;
determining a prediction accuracy associated with the base station determining the second group of beams based on comparing the first group of beams and the second group of beams; and
transmitting information associated with the prediction accuracy to the base station.

2. The method of claim 1, further comprising:
calculating a set of key performance indicators (KPIs) associated with the base station determining the second group of beams, wherein the set of KPIs is determined based on one or more of the set of L1-RSRP measurement values, the first group of beams, or the second group of beams; and
transmitting information indicating the set of KPIs to the base station.

3. The method of claim 1, wherein a quantity of beams included in one or more of the first group of beams or the second group of beams is one beam.

4. The method of claim 1, wherein determining the prediction accuracy comprises:
determining that the prediction accuracy comprises a first value based on the first group of beams matching the second group of beams; or
determining that the prediction accuracy comprises a second value, that is different from the first value, based on the first group of beams being different from the second group of beams.

5. The method of claim 1, wherein receiving the information indicating the second group of beams comprises:
receiving a physical downlink shared channel (PDSCH) communication that includes the information indicating the second group of beams.

6. The method of claim 5, wherein the PDSCH communication further includes downlink data associated with the UE.

7. The method of claim 1, wherein the information indicating the second group of beams is received via a beam included in the second group of beams.

8. The method of claim 1, wherein the information indicating the set of L1-RSRP measurement values is transmitted via a beam included in the first group of beams.

9. The method of claim 1, wherein transmitting the information indicating the set of L1-RSRP measurement values comprises:
transmitting the information indicating the set of L1-RSRP measurement values, the first group of beams, and the set of probabilities.

10. A method performed by a base station, comprising:
performing beam sweeping within a set B of beams;
receiving, from a user equipment (UE), a set of layer 1 reference signal received power (L1-RSRP) measurement values for the set B of beams and information identifying a first group of beams, wherein the set of L1-RSRP measurement values includes a respective L1-RSRP measurement value for each beam of the set B of beams;
determining a set of probabilities for a set A of beams based on the set of L1-RSRP measurement values, wherein the set of probabilities includes, for each beam of the set A of beams, a respective probability that each beam is in a second group of beams, of the set A of beams, having a higher L1-RSRP measurement value than other beams, of the set A of beams, that are not included in the second group of beams;
determining the second group of beams based on the set of probabilities;
comparing the first group of beams and the second group of beams; and
determining a prediction accuracy associated with determining the second group of beams based on comparing the first group of beams and the second group of beams.

11. The method of claim 10, wherein a quantity of beams included in one or more of the first group of beams or the second group of beams is one beam.

12. The method of claim 10, wherein determining the prediction accuracy comprises:
determining that the prediction accuracy comprises a first value based on the first group of beams matching the second group of beams; or
determining that the prediction accuracy comprises a second value, that is different from the first value, based on the first group of beams being different from the second group of beams.

13. The method of claim 10, wherein information indicating the set of L1-RSRP measurement values and the first group of beams is received via a beam included in the first group of beams.

14. A user equipment (UE), comprising:
one or more memories; and
one or more processors, coupled to the one or more memories, configured to:
determine a set of layer 1 reference signal received power (L1-RSRP) measurement values for a set B of beams, wherein the set of L1-RSRP measurement values includes a respective L1-RSRP measurement for each beam of the set B of beams;
determine a set of probabilities for a set A of beams based on the set of L1-RSRP measurement values, wherein the set of probabilities includes, for each beam of the set A of beams, a respective probability that each beam is in a first group of beams, of the set A of beams, having a higher L1-RSRP measurement value than other beams, of the set A of beams, that are not included in the first group of beams;
determine the first group of beams based on the set of probabilities;
transmit information identifying the set of L1-RSRP measurement values to a base station;
receive information identifying a second group of beams, of the set A of beams, from the base station;
compare the first group of beams and the second group of beams;
determine a prediction accuracy associated with the base station determining the second group of beams based on comparing the first group of beams and the second group of beams; and
transmit information associated with the prediction accuracy to the base station.

15. The UE of claim 14, wherein the one or more processors are further configured to:
calculate a set of key performance indicators (KPIs) associated with the base station determining the second group of beams, wherein the set of KPIs is determined based on one or more of the set of L1-RSRP measurement values, the first group of beams, or the second group of beams; and
transmit information indicating the set of KPIs to the base station.

16. The UE of claim 14, wherein a quantity of beams included in one or more of the first group of beams or the second group of beams is one beam.

17. The UE of claim 14, wherein the one or more processors, to determine the prediction accuracy, are configured to:
determine that the prediction accuracy comprises a first value based on the first group of beams matching the second group of beams; or
determine that the prediction accuracy comprises a second value, that is different from the first value, based on the first group of beams being different from the second group of beams.

18. The UE of claim 14, wherein the one or more processors, to receive the information indicating the second group of beams, are configured to:
receive a physical downlink shared channel (PDSCH) communication that includes the information indicating the second group of beams and downlink data associated with the UE.

19. The UE of claim 14, wherein the information indicating the second group of beams is received via a beam included in the second group of beams.

20. The UE of claim 14, wherein the information indicating the set of L1-RSRP measurement values is transmitted via a beam included in the first group of beams.
